(19) United States
(12) Patent Application Publication
(10) Pub. No.: US 2019/0222933 A1
(43) Pub. Date: Jul. 18, 2019

(54) Daisy Chained Audio Speaker System

(71) Applicant: Walter Lancaster, Los Angeles, CA (US)

(72) Inventor: Walter Lancaster, Los Angeles, CA (US)

(21) Appl. No.: 16/209,664

(22) Filed: Dec. 4, 2018

Related U.S. Application Data
(63) Continuation-in-part of application No. 14/757,036, filed on Jun. 22, 2014, now abandoned.

(51) Int. Cl. H04R 5/02; H04R 5/04; H04R 1/02; H04R 3/12

(52) U.S. Cl. CPC H04R 5/02; H04R 3/12; H04R 1/026; H04R 5/04

(57) ABSTRACT

The “Daisy Chained Audio Speaker System” is audio speaker hybridization comprised of a numerical count of audio speakers electrically wire harnessed forming an in series or parallel electrical circuit with an optional circuital branch configuration affixed to the required host frame of an article of jewelry of a chain (ornamental or genuine) intended to complete a neck circumference, new in the art herein is when an article of jewelry of a chain (ornamental or genuine) as intended to complete a neck circumference enjoins a numerical count of audio speakers electrically wire harnessed forming an in series or parallel electrical circuit with an optional circuital branch configuration affixed to it, as taught herein this present invention is solely empowered by the end-users selected external empowering audio input source signal that supplies the audio source empowering voltage by end-users selected external connectivity.

### CROSS REFERENCE TO RELATED APPLICATION

This application is a continuation-in-part of the related U.S. patent application Ser. No. 17/757,036 filed Date: Jun. 22, 2014, the contents of which are fully incorporated herein by reference for all purposes in keeping with (37 CFR 1.5).

### FIELD OF INVENTION

This present application of invention of the First Named Inventor “Walter Lancaster” herein “Teaches” of a series of audio speakers connected by their respective positive and negative (and or ground wire) leads to their respective positive and negative (and or ground) wire leads of male to female pin connectors (2-pin selected and utilized herein) and this electrical connectivity manifests in a “parallel” electrical configuration wire harness (as shown herein) although could function with a “series” electrical configuration. The present invention provides means for audio reception and tele-communications and manifests in the form and structure of the article of jewelry of a chain (ornamental or genuine) to be expressly worn around the neck upon completion and is capable of 360 degree twists.

### BACKGROUND OF THE INVENTION

Prior art to the present invention is any audio speaker system that is electrical wire harnessed, that functions at it's audio speaker numerical count with the introduction of an audio input source signal, these audio systems include home stereo speaker systems, automobiles, night clubs and arenas, movie theaters, audible alarms, . . . ear plugs, headphones, stereo boom boxes, table top audio speaker systems, buildings, vessels (including airlines, boats, and submarines), and all intercom systems etc.. Furthermore, uniquely herein the present invention, any article of jewelry known as a chain (ornamental or genuine) is the required host frame for the support of the present invention herein.

The present invention is new, unique and different from all prior art. The present invention is intended to be worn upon the body (particularly around the neck) and becomes secured by clasp for closure behind the neck of the end user (plastic hooks are shown herein). The present invention is not bodily intrusive. The present invention may be placed upon any logical surface and shall function from upon such surface, ie: a table top.

The present invention combines the fashion and industry of j ewelry manufacture (ornamental or genuine) and the industry and the manufacture of audio speakers and the manufacture of the pin connectors (herein shown as forming an electrical wiring harnessed as conduit connectivity) and of 3.5 mm audio input jacks (male and female).

### SUMMARY OF INVENTION

By providing a present invention that must be affixed to the requisite host of the article of jewelry of a chain (ornamental or genuine) to be expressly worn around the neck.

The disclosed exemplary embodiment's provide a present invention that when expressly worn around the neck the article of jewelry of a chain (ornamental or genuine) presents with audio reception and tele-communications capabilities solely empowered by the voltage and amplitude of the audio input source signal.

In one embodiment the present invention utilizes the connectivity of a 3.5 mm line-in audio jack (male) (stereo or mono) by 3 ft. wire connected to an external audio source device.

In another embodiment the present invention utilizes the connectivity of a 3.5 mm line-in audio jack (female) (stereo or mono) by 3 ft. wire connected to an external audio source device.

Further objects, features, advantages and properties of the present invention application will become apparent from the detailed description.

### BRIEF DESCRIPTION OF THE DRAWINGS

Although the teachings of the present application is described in detail for purposes of illustration, it is understood that such detail is solely for this purpose, and variations can be made without departing from the scope of the teachings of this application. For example the requisite host of an article of jewelry of a Chain (ornamental or genuine) [25] need not be “Jewelry” at all, yet the host frame of support is a must for the series of component parts to complete a neck circumference as herein this present application.

In the following detailed portion of the present invention application, the teachings of the present application will be explained in more detail with reference to the example embodiment's shown in the drawings, in which:

FIG. 1 is a 3.5 mm (male) Audio Jack (mono or stereo) [01] with a 3 ft. Wire [02] connected to a (male) 2 Pin Connector [04] as all component parts are to become connected for the resulting completed electrical wire harnessed series [FIG. 19].

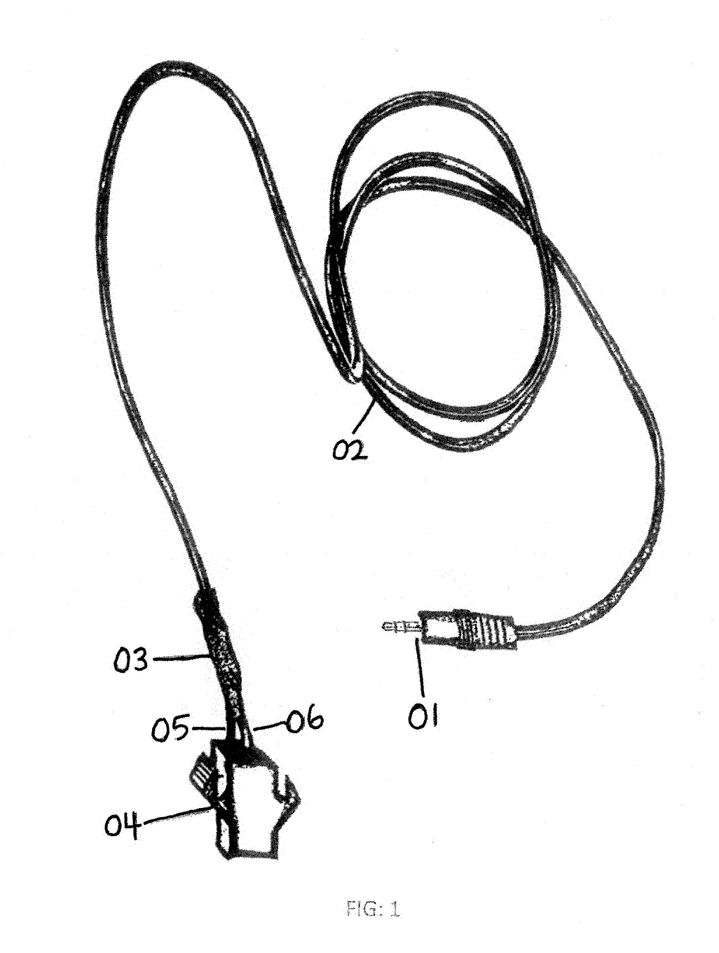

FIG. 2 is a 3.5 mm (male) Audio Jack (mono or stereo) [01] with a 3 ft. Wire [02] connected to a (male) 2 Pin Connector [04] and an (optional branch) [7] line-in microphone [08] as all component parts are to become connected for the completed resulting electrical wire harnessed series [FIG. 19].

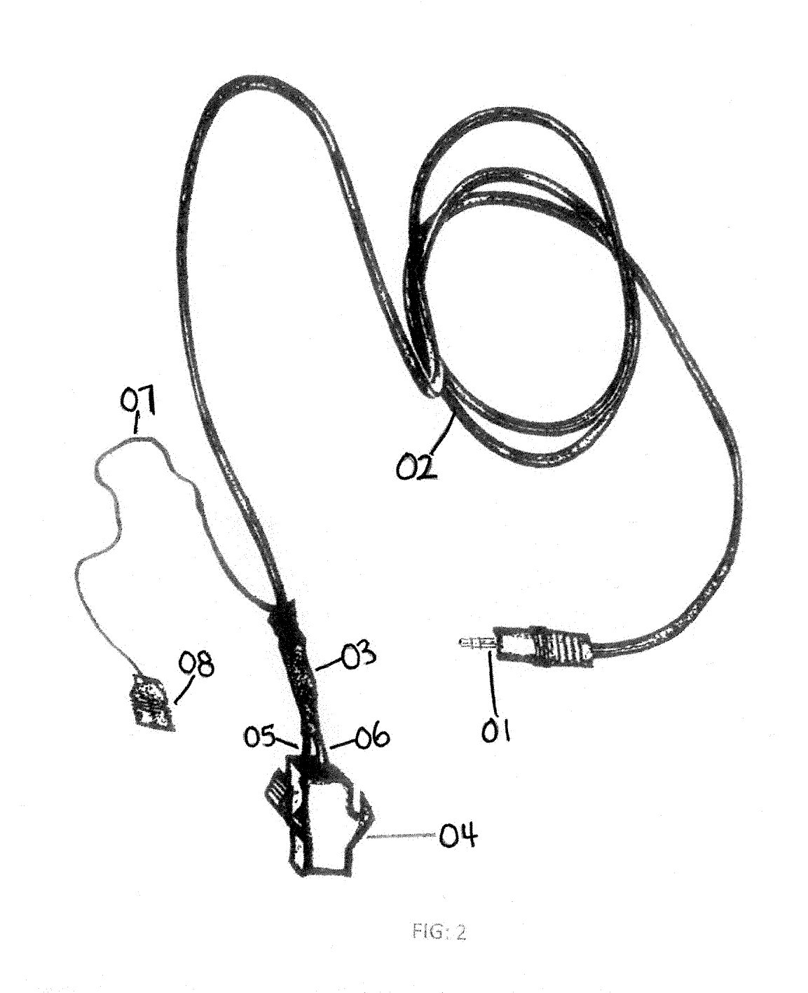

FIG. 3: is a 3.5 mm (female) Audio Jack (mono or stereo) [09] with a 3inch Wire [03] connected to a (male) 2 Pin Connector [04] as all parts are to become connected for the completed resulting electrical wire harnessed series [FIG. 19].

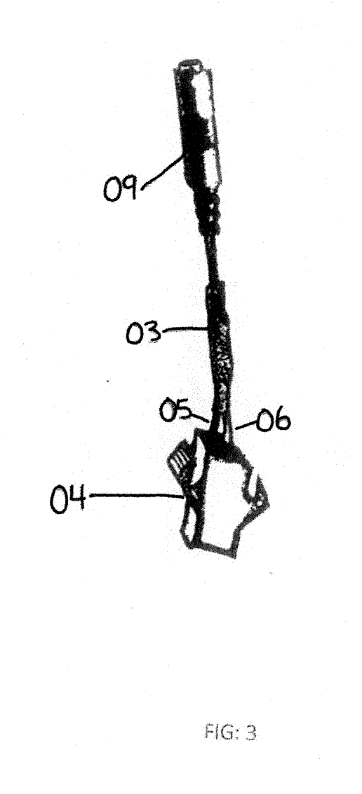

FIG. 4: is a 3.5 mm (female) Audio Jack (mono or stereo) [09] with a 3 inch Wire [03] connected to a (male) 2 Pin Connector [04] and an (optional branch) [07] line-in Microphone [08] as all component parts are to become connected for the completed resulting electrical wire harnessed series [FIG. 19].

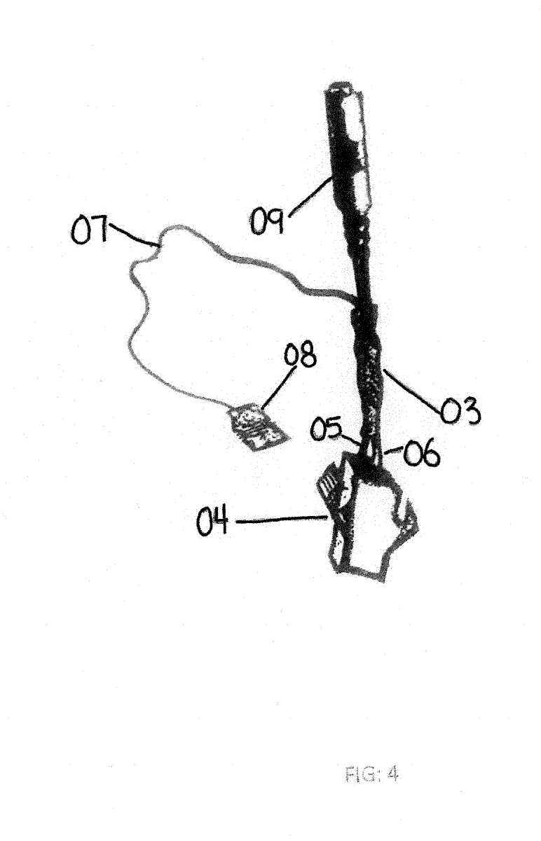

FIG. 5: is an Upper Front View of an Audio Speaker [18] connected by wire leads [13][14] to two (female) 2 Pin Connectors [10] by wire leads [11][12][15][16] as all component parts are to become connected for the resulting completed electrical wire harnessed series [FIG. 19].

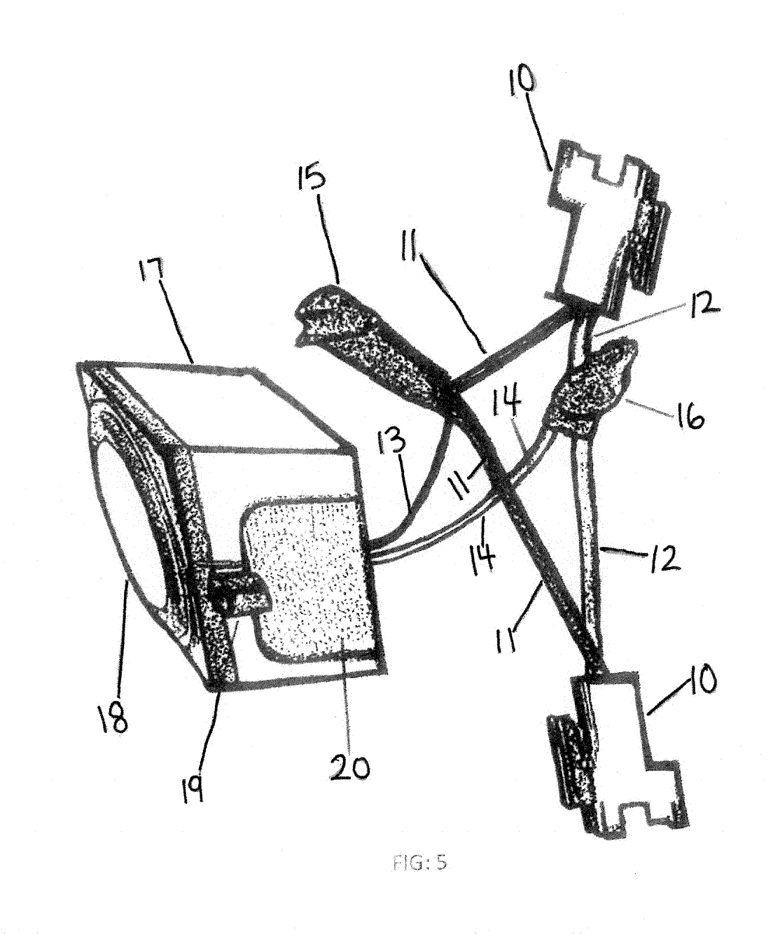

FIG. 6: is an Upper Front View of an Audio Speaker [18] connected by wire leads [13][14] to one (female) 2 Pin Connector [10] by wire leads [11][12] to one (male) 2 Pin Connector [04] by wire leads [05][06][15][16] as all component parts are to become connected for the resulting completed electrical wire harnessed series [FIG. 19].

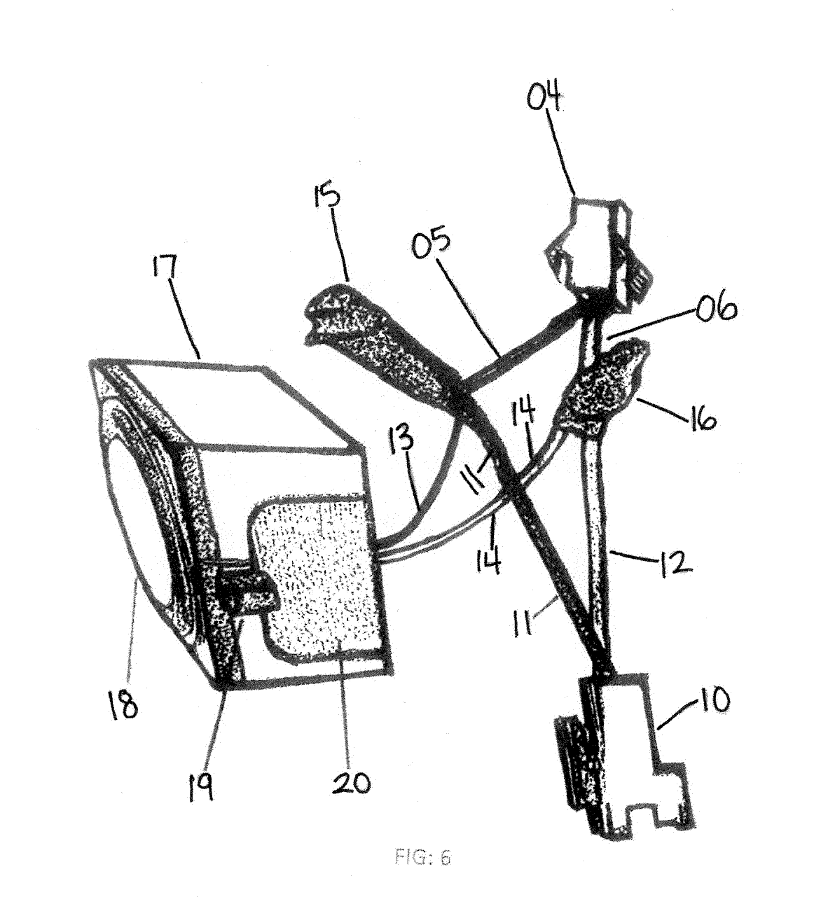

FIG. 7: is an Upper Rear View of an Audio Speaker Cubed case [17] connected by wire leads [13][14] to one (female) 2 Pin Connector [10] by wire leads [11][12] to one (male) 2 Pin Connector [04] by wire leads [05][06][15][16] as all component parts are to become connected for the resulting completed electrical wire harnessed series [FIG. 19].

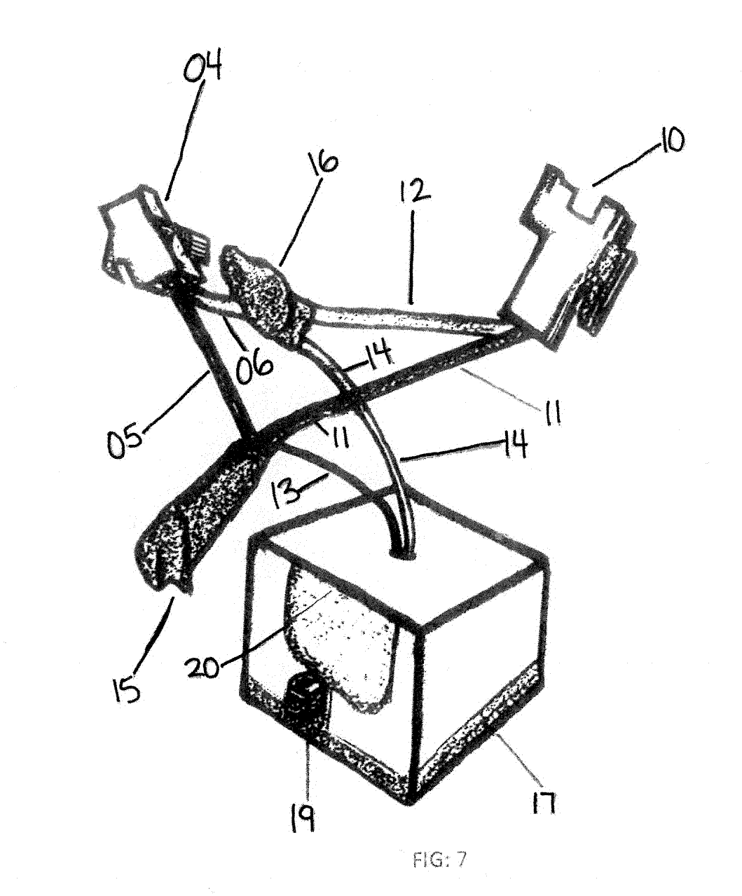

FIG. 8: is an Upper Rear View of another identical Audio Speaker Cubed case [17] connected by wire leads [13][14] to one (female) 2 Pin Connector [10] by wire leads [11][12] and to one (male) 2 Pin Connector [04] by wire leads [05][06][15][16] as all component parts are to become connected for the resulting completed electrical wire harnessed series [FIG. 19].

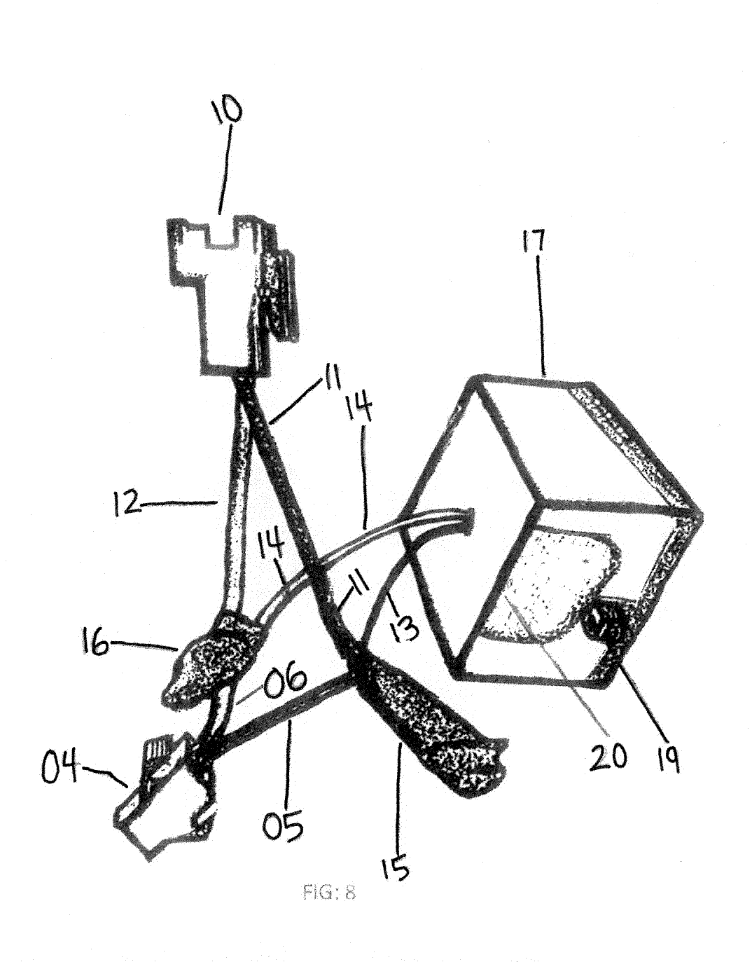

FIG. 9: is an Upper Rear View of another identical Audio Speaker Cube case [17] connected by wire leads [13][14] to one (female) 2 Pin Connector [10] by wire leads [11][12] and to one (male) 2 Pin Connector [04] wire leads [05][06][15][16] as all component parts are to become connected for the resulting completed electrical wire harnessed series [FIG. 19].

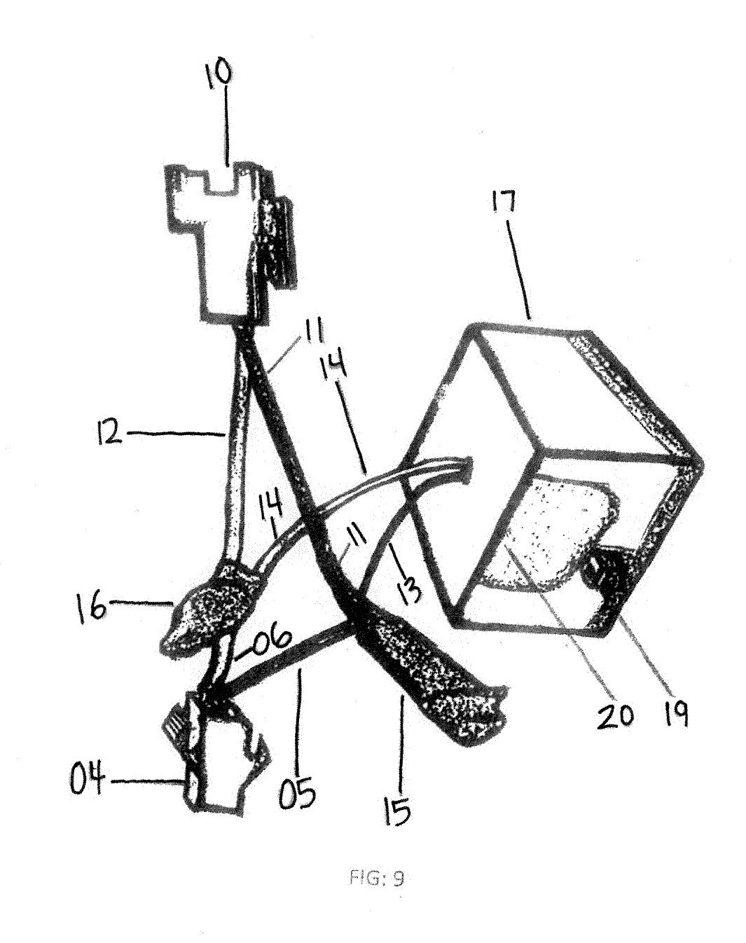

FIG. 10 is an Upper Front View of another identical Audio Speaker [17][18] connected by wire leads [13][14] to one (female) 2 Pin Connector [10] by wire leads [11][12] and to one (male) 2 Pin Connector [04] by wire leads [05][06][15][16] as all component parts are to become connected for the resulting completed electrical wire harnessed series [FIG. 19].

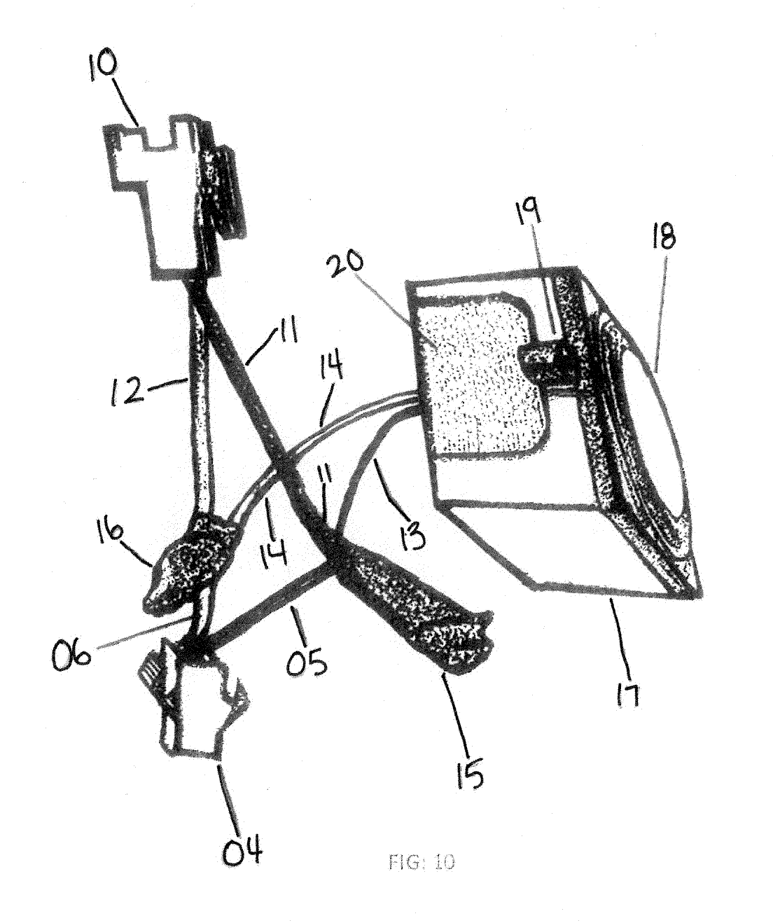

FIG. 11 is an Upper Rear View of another identical Audio Speaker Cube case [17] connected by wire leads [13][14] to one (female) 2 Pin Connector [10] by wire leads [11][12] and to one (male) 2 Pin Connector [04] by wire leads [05][06][15][16] and sealed with electrical tape [21] as all component parts are to become connected for the resulting completed electrical wire harnessed series [FIG. 19].

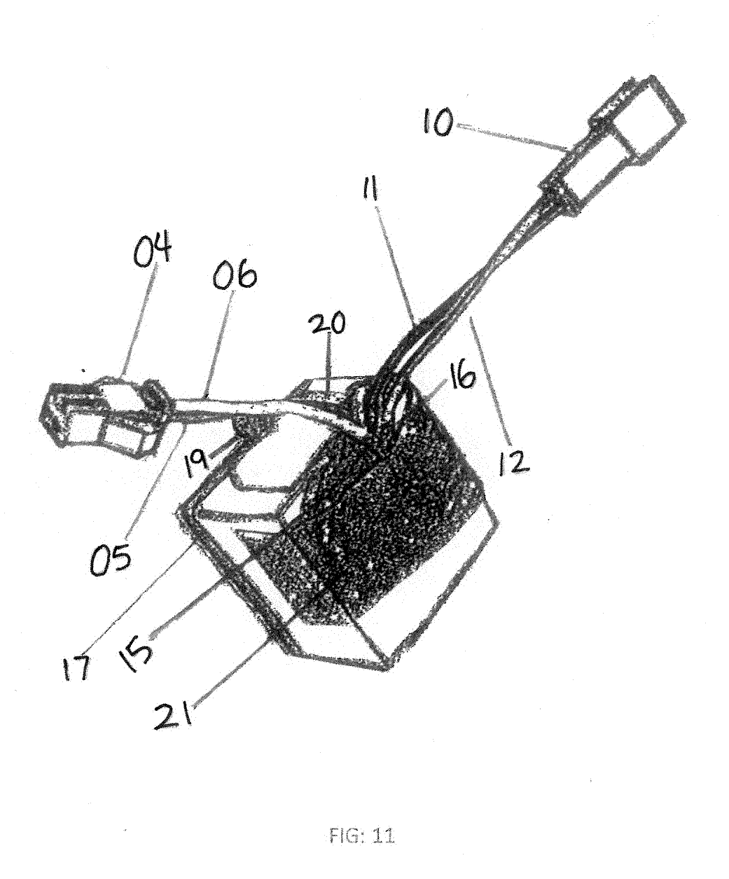

FIG. 12 is an Upper Rear View of another identical Audio Speaker Cube case [17] connected by wire leads [13][14] to one (female) 2 Pin Connector [10] by wire leads [11][12] and to one (male) 2 Pin Connector [04] by wire leads [05][06][15][16] concealed in an (optional) flexible plastic tube [22] as all component parts are to become connected for the resulting completed electrical wire harnessed series [FIG. 19].

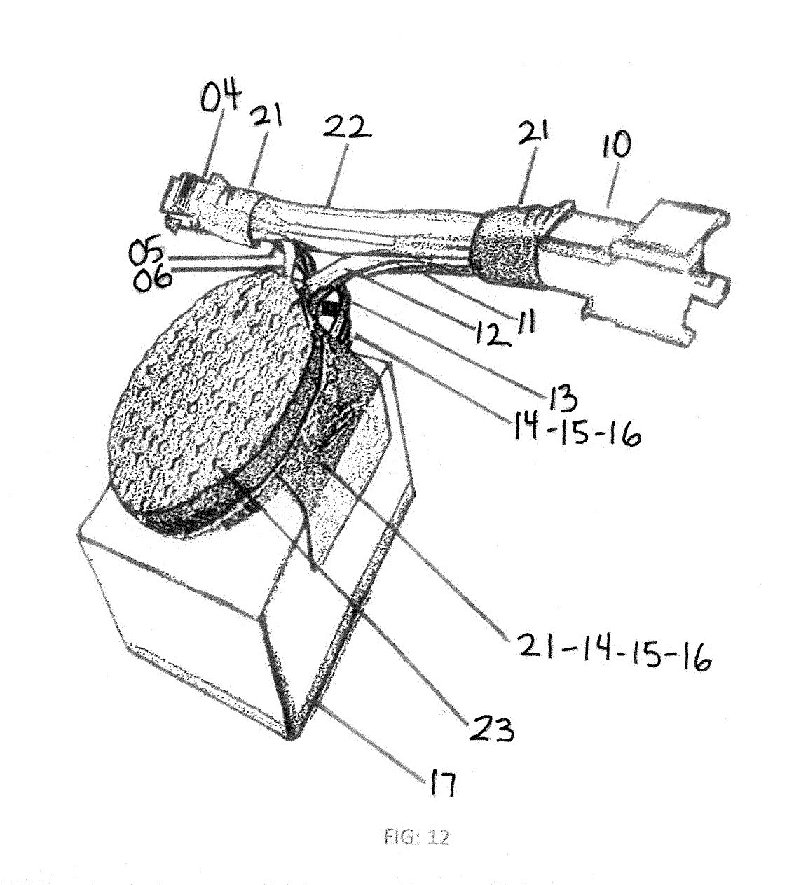

FIG. 13: is an Upper Front View of the Semi-Circle metal crossbar [24] used to maintain the Semi-Circular form of the article of jewelry of a Chain (ornamental or genuine) [25] when affixed to the completed electrical wire harnessed series [FIG. 19].

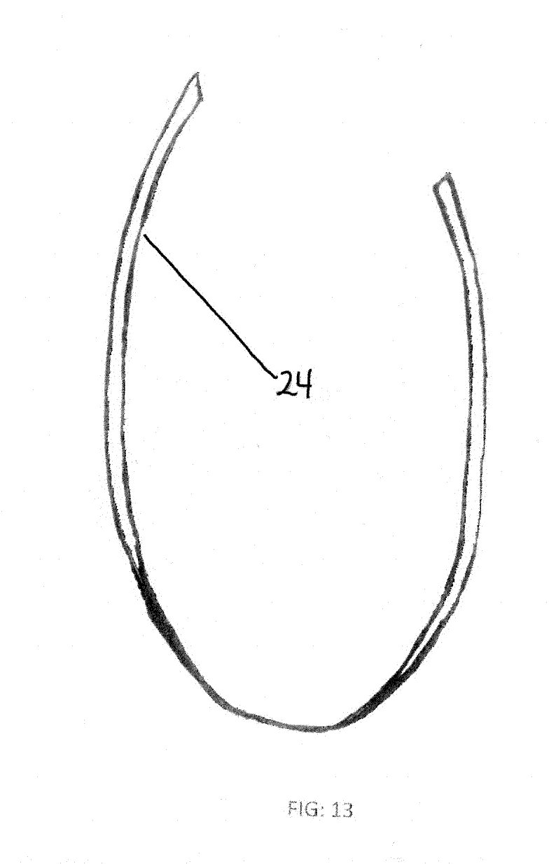

FIG. 14: is a Segmented Front View of an identical Audio Speaker [17][18] of the chosen numerical count of six to seven for this particular model presented, as attached/affixed to the host frame support of the article of jewelry of a Chain (ornamental or genuine) [25].

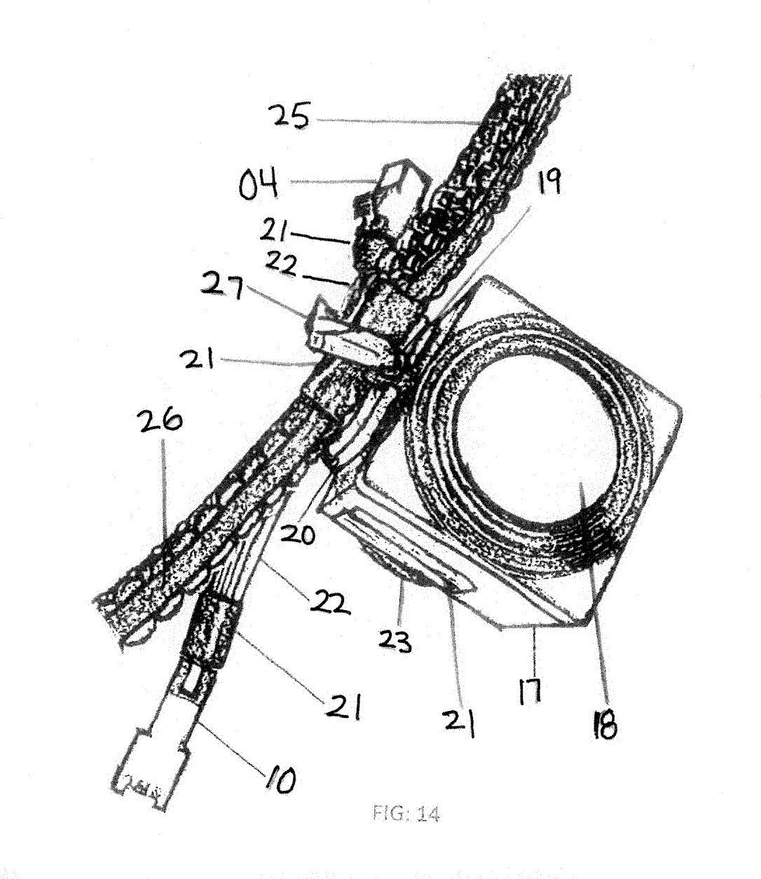

FIG. 15: is an Upper Front View of six count identical Audio Speaker Cubed Case(s) [17][18] model of the present invention herein, as fully attached and affixed to the requisite article of Jewelry of a Chain (ornamental or genuine) [25]. The component connected by 2 Pin Connector parts [4][10] are now coated and sealed with herein (black) Acrylic layers [28] (although the Acrylic layer's [28] can be any color). [FIG. 15] is the present invention herein upon full completion.

FIG. 16: is an Upper Rear View of six count identical Audio Speaker Cubed Case(s) [17][18] model of the present invention herein, as fully attached and affixed to the requisite article of Jewelry of a Chain (ornamental or genuine) [25]. The component connected by 2 Pin Connector parts [4][10] are now coated and sealed with herein (black) Acrylic layers [28] although can be any color [28]. [FIG. 16] is the present invention herein upon full completion.

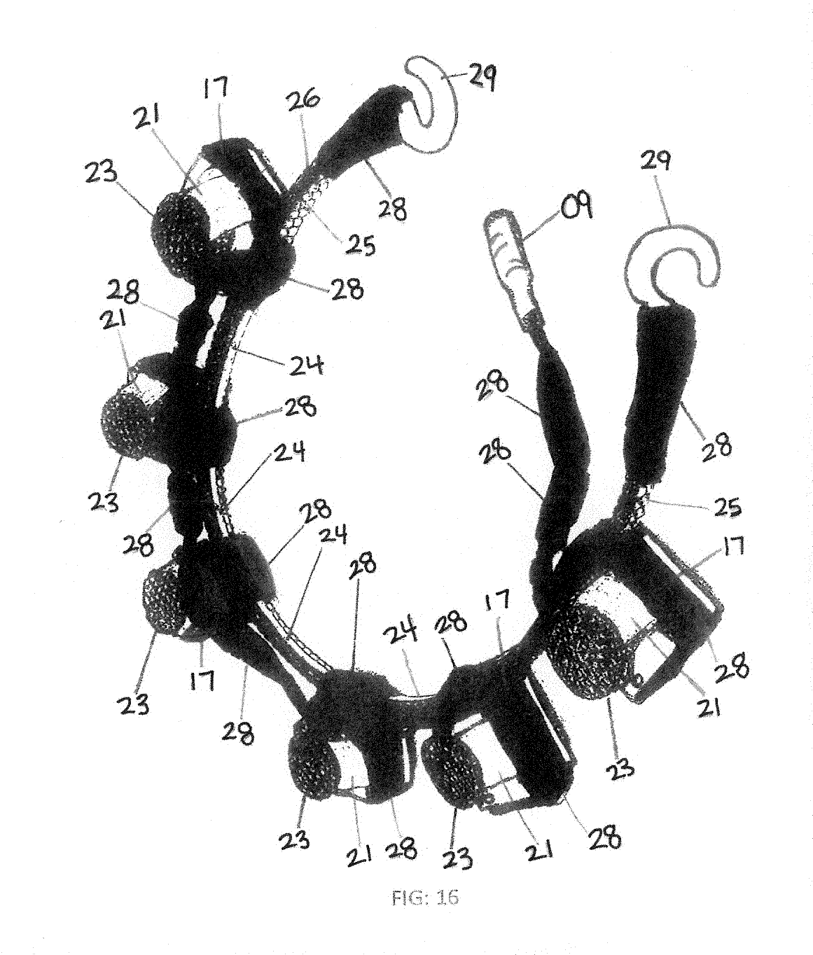

FIG. 17: is an Upper Front View of a seven count identical Audio Speaker [17][18] model of the present invention herein, as the selected component parts connected by their wire leads have formed an electrical wire harness at wire leads [15][16] as by the connected to 2 Pin Connectors [04][10].

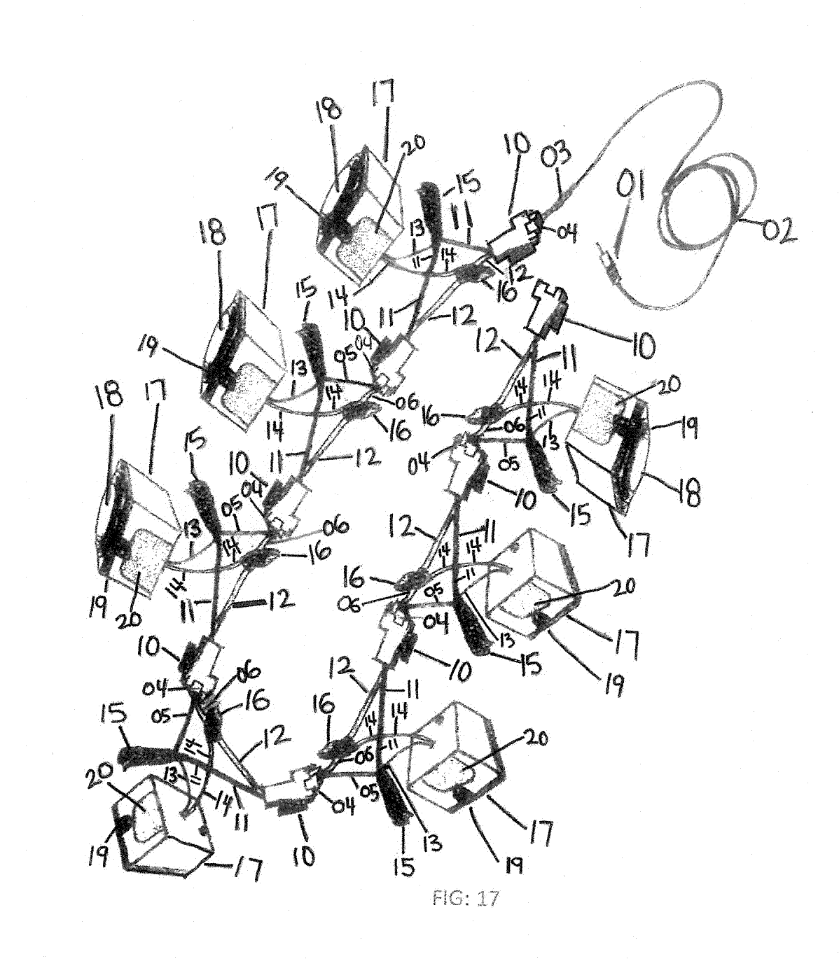

FIG. 18: is an Upper Front View of a seven count identical Audio Speaker [17][18] model of the present invention herein, with an (optional branch) [7] line-in microphone [08] as the selected component parts connected by their wire leads [11][12][13][14][15][16] of 2 Pin Connectors [04][10] forming an electrical wire harness [FIG. 19].

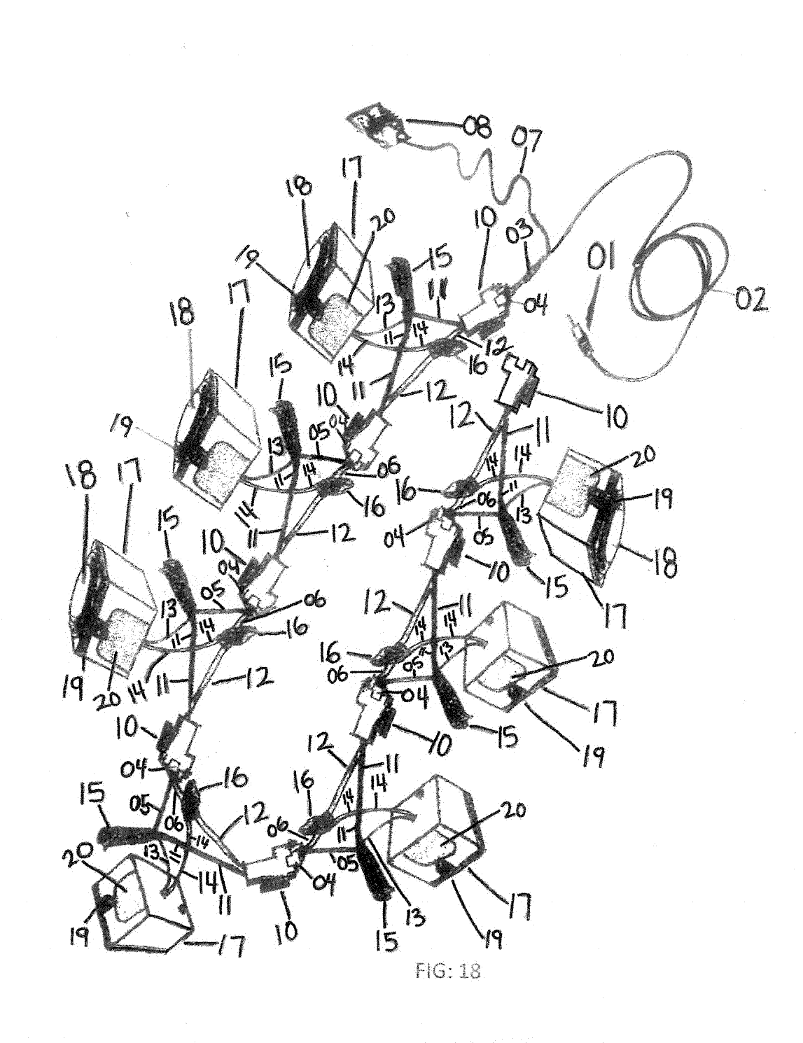

FIG. 19: is an Upper Front View of a seven count identical Audio Speaker [18] model of the present invention herein, with (2 female) 3.5 mm Audio Jacks (mono or stereo) [09] as the selected component parts connected by their wire leads [11][12][13][14][15][16] of 2 Pin Connectors [04][10] forming an electrical wire harness [FIG. 19].

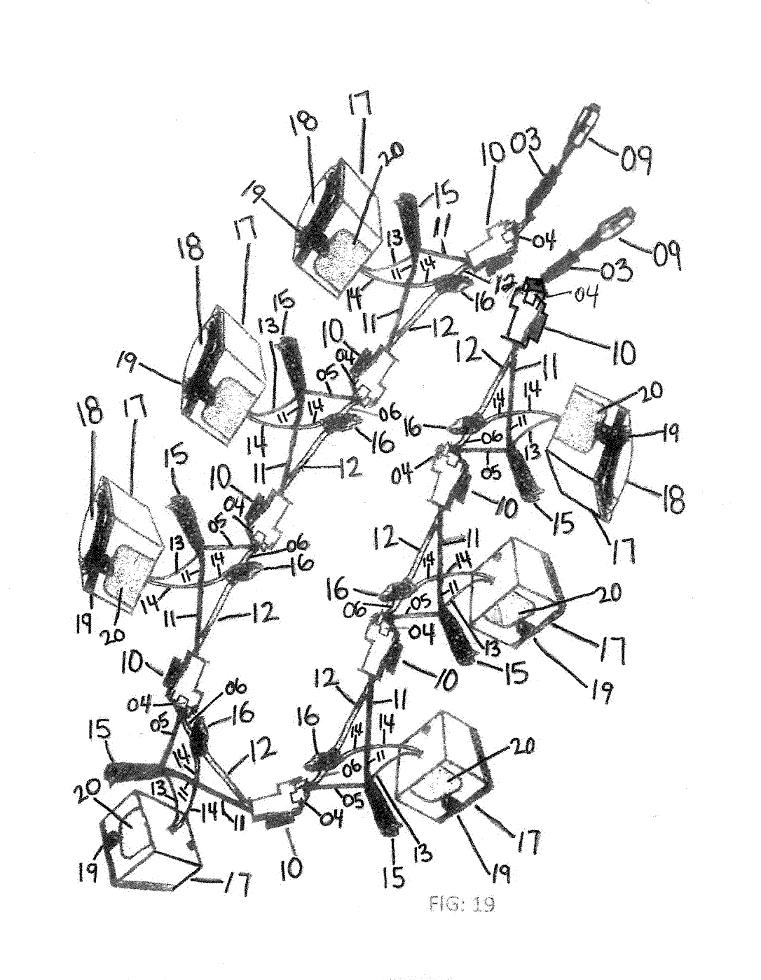

### DETAILED DESCRIPTION OF THE INVENTION

The first named inventor for the present invention herein tentatively entitled “The Daisy Chained Audio Speaker System” teaches a wire harnessed connected series of (identical or non-identical) Audio Speakers. The term “Daisy Chained” is actually Computer language where separate and distinct machines become connected by a “SCSI” connector plug and wire interface, whereby a (1) Printer is connected to a (2) External Floppy Disk drive, and it to a (3) External CD/DVD Burner Drive, and each of these now “Daisy Chained Computer Peripherals” become connected by “SCSI” interface at the rear of a Computer at the installed “SCSI Card” interface thus providing full empowerment and acknowledgment and control of each of the separate machines that are made operable in such a “Daisy Chained” configuration.

The present invention component parts herein become electrically wire harnessed by all wire leads [11][12][13][14][15][16] as shown herein joined by 2Pin Connectors [4][10] The term “Harnessed” is a system of insulated conducting wires bound together in service upon a machine.

The selected numerical count of Audio Speakers [17][18] in the present invention herein of (6 to 7) may be connected in a series or parallel electrical configuration. The term “series” means that the components are connected end-to-end in a line forming a single path for electrons to flow.

Therefore, if in a “series” electrical configuration, the amount of current is the same through any component in an electrical circuit connected across each components wire leads. The term “parallel” means that the component parts are connected across each other, forming exactly two sets of electrically common points[ 05][06][11][12][13][14][15][16]. The term “branch” in a parallel circuit is a path for electric current formed by one of the load components (such as the optional microphone and wire herein [07][08].

The present invention herein includes at least the following basic components: a selected numerical count of Audio Speakers [[17][18], the harnessing of the electrical wire leads to form a “series” or “parallel” configuration [15][16] with an optional “branch” [7], the requisite host of a “jewelry chain” (ornamental or genuine) [25] for the mounting and support thus completion of the structure. The (female or male) 3.5 mm (stereo or mono) Jack [01][09] is the interface where externally connected is the required Audio Input Source signal empowering electrical current. The required Audio Input Source signal empowering electrical current may be provided by such as an external Bluetooth Receiver/Transmitter or such as by a physical line-in Audio Source electrical input signal or as plugged into to a Mobile Device or a Portable Radio or CD Player or MP3 Player etc. The 3.5 mm (stereo or mono) Jack is the interface component for the present invention herein.

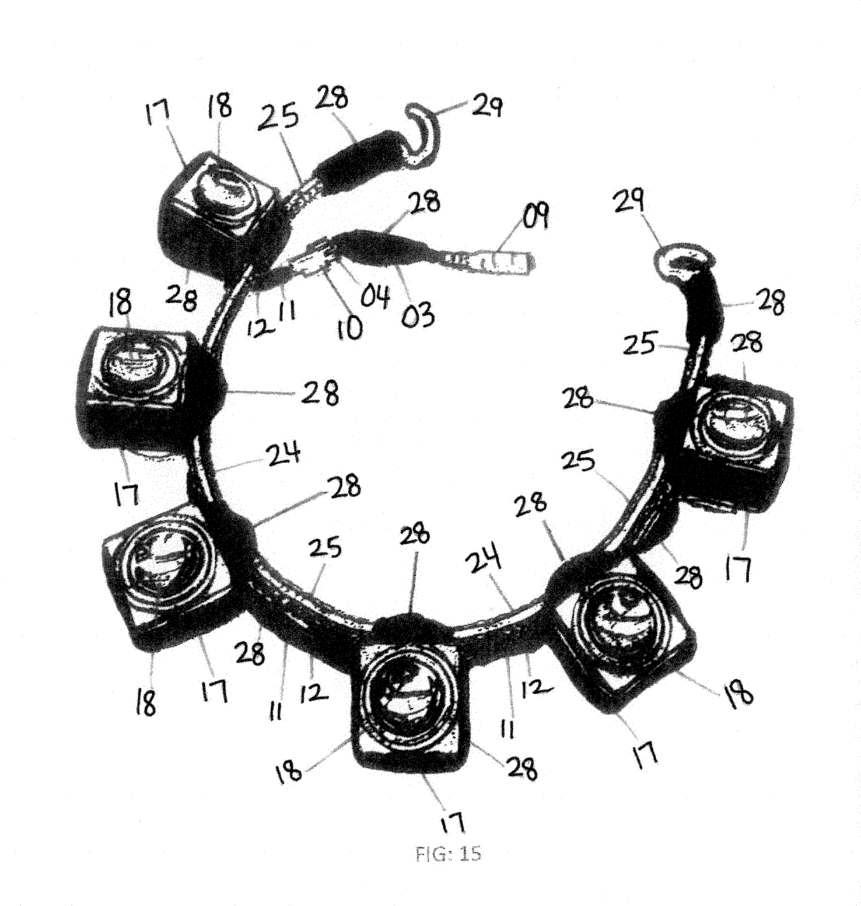

The dimensions of the component parts herein may vary, and as well the dimension of the requisite host of a “jewelry chain” (ornamental or genuine) [25] for the support and completion of the structure [FIG. 15].

The junction of component parts wire leads [15][16] of the present invention herein may be soldered together. Heat shrink and electrical tape may be used to seal and separate the soldered connection wire leads [03][15[16]. The Audio Speakers [18] and the (female or male) 3.5 mm (stereo or mono) Jack [01][09] are modified to each bear a 2Pin connector (female or male) [04][10].

The connected component parts assembled then become affixed to the requisite host of a “jewelry chain” (ornamental or genuine) [25] for the form and support and completion of this structure.

The length of the present invention herein may vary pursuant to the selected numerical count of Audio Speakers [17][18], and likewise shall the length of the requisite host of a “jewelry chain” (ornamental or genuine) [25] for the form and support and completion of the structure.

The present invention is solely powered by the Electrical Voltage and Amplitude of the Audio Input Source signal. The present invention requires absolutely no electrical charge and bears no on board power supply.

The present invention herein is “controlled” by the Electrical Voltage and Amplitude of the Audio Input Source signal, as the service of the end-user-chosen Audio Input source signal is maintained, and the Audio Input source signal is only controlled at and from the Audio Input empowering source providing device or machine externally connected by the end-user.

The requisite host of a “jewelry chain” (ornamental or genuine) [25] for the form and support and completion of the structure herein may vary in design and in composite element and in value for the exploitation of how exquisite is the “jewelry chain” (ornamental or genuine) [25] supporting the completion of the structure herein.

### An Example of the Daisy Chained Audio Speaker System as an Accessory

The completed structure of the present invention herein is to become secured behind the neck by clasp or hooks for closure (as shown herein) [29]. The present invention as a “Chain” [FIG. 15] completes a full neck circumference of the end-users neck. The “Daisy Chained Audio Speaker System” when in completion as affixed to the “Jewelry Chain” (ornamental or genuine) [25] now greatly increases the value of both the jewelry chain and the present invention herein as exploited by the end-user, tentatively entitled the “Daisy Chained Audio Speaker System” [FIG. 15].

### DETAILED DESCRIPTION OF THE INVENTION

The first named inventor for the present invention herein tentatively entitled “The Daisy Chained Audio Speaker System” teaches a wire harnessed connected series of (identical or non-identical) Audio Speakers. The term “Daisy Chained” is actually Computer language where separate and distinct machines become connected by a “SCSI” connector plug and wire interface, whereby a 1. Printer is connected to a 2. External Floppy Disk drive, and it to a 3. External CD/DVD Burner Drive, and each of these now “Daisy Chained Computer Peripherals” become connected by “SCSI” interface at the rear of a Computer at the installed “SCSI Card” interface thus providing full empowerment and acknowledgment and control of each of the separate machines that are made operable in such a “Daisy Chained” configuration.

The present invention component parts herein become electrically wire harnessed by all wire leads [11][12][13][14][15][16] as shown herein joined by 2Pin Connectors [04][10]. The term “Harnessed” is a system of insulated conducting wires bound together in service upon a machine.

The selected numerical count of Audio Speakers in the present invention herein of (6 to 7) may be connected in a series or parallel electrical configuration. The term “series” means that the components are connected end-to-end in a line forming a single path for electrons to flow. Therefore, if “In Series” electrical configuration, the amount of current is the same through any component in an electrical circuit connected across each components wire leads. The term “parallel” means that the component parts are connected across each other, forming exactly two sets of electrically common points [05][06][11][12]13][14][15][16]. The term “branch” in a parallel circuit is a path for electric current formed by one of the load components such as the optional microphone wire herein [07][08].

The present invention herein includes at least the following basic components: a selected numerical count of Audio Speakers [17][18], the harnessing of the electrical wire leads to form a “series” or “parallel” configuration with an optional “branch”, the requisite host of a “jewelry chain” (ornamental or genuine) for the support and completion of the structure [25]. The (female [09] or male [01]) 3.5 mm (stereo or mono) Jack is the interface where externally connected is the required Audio Input Source signal electrical current. The required Audio Input Source signal electrical current may be provided by such as an external Bluetooth Receiver/Transmitter or such as by a physical line-in [02] Audio Source electrical input signal or as plugged into to such device as a Mobile Device or a Portable Radio or CD Player or MP3 Player etc. The 3.5 mm (stereo or mono) Audio Jack (female [09] or male [01]) is the Empowering Audio interface component for the present invention herein.

The dimensions of the component parts herein may vary, and as well the dimension of the requisite host of a “jewelry chain” (ornamental or genuine) [25] for the support and completion of the structure.

The component parts wire leads of the present invention herein may be soldered together [05][06][11][12]13][14][15][16]. Heat shrink and electrical tape may be used to seal and separate the soldered connection wire leads [05][06][11][12]13][14][15][16]. The Audio Speakers and the (female or male) 3.5 mm (stereo or mono) Audio Jack interface in the present invention as modified each bear a (2Pin connector) [01][05]06][09]. The connected component parts assembled then become affixed to the requisite host of a “jewelry chain” (ornamental or genuine) for the support and completion of this structure [25].

The length of the present invention herein may vary pursuant to the selected numerical count of Audio Speakers, and likewise shall the length of the requisite host of a “jewelry chain” (ornamental or genuine) for the support and completion of the structure.

The present invention is solely powered by the Electrical Voltage and Amplitude of the Audio Input Source signal. The present invention requires absolutely no electrical charge and bears no on board power supply.

The present invention herein is “controlled” by the Electrical Voltage and Amplitude of the Audio Input Source signal, as the service of the end-user-chosen Audio Input source signal is maintained, and the Audio Input source signal is only controlled at and from the Audio Input source providing device or machine externally connected.

The requisite host of a “jewelry chain” (ornamental or genuine) for the support and completion of the structure herein may vary in design and in composite element and in value, in exploitation of how exquisite is the “jewelry chain” (ornamental or genuine) supporting the completion of the structure herein [25].

### An Example of the Daisy Chained Audio Speaker System as an Accessory

The completed structure of the present invention herein is to become secured behind the neck by clasp or hooks for closure (as shown herein) [27]. The present invention as a “Chain” completes a full neck circumference of the end-users neck [FIG. 15]. The “Daisy Chained Audio Speaker System” when in completion as affixed to the “Jewelry Chain” (ornamental or genuine) now greatly increases the value of both the jewelry chain and the present invention herein as exploited, tentatively entitled the “Daisy Chained Audio Speaker System” [FIG. 15].

1:
1. The Daisy Chained Audio Speaker System herein is a Series of Audio Speakers (identical or non-identical) and two line in 3.5 mm or ¼ inch. Female Stereo Audio Jacks with each part then connected by the introduced 2Pin connectors, the 2Pin connected parts are then mounted and secured to the host frame of an article of ornamental, costume, or genuine jewelry of a chain to make possible a neck circumference as the chain is clasped closed behind the end-users neck for security.
2. A Daisy Chained Audio Speaker System according to claim 1 wherein the Audio Speaker System upon completion as comprising the requisite harnessed component parts as mounted and secured to the host frame of an article of ornamental, costume, or genuine jewelry of a chain to make possible a neck circumference as the chain is clasped closed behind the end-users neck for security becomes an Audio Stereo Speaker System that is worn “Personally” and “Hands Free” for exploitation to include other persons within radius and view and vicinity whom (1) adore the chain and (2) can hear it also.
3. A Daisy Chained Audio Speaker System according to claim 1 wherein The Daisy Chained Audio Chain Speaker System is to be worn expressly upon the human body around the Neck as a means of “hand free” audio in the form a “Chain” comprising a “Jewelry Chain” (ornamental or genuine) affixed to the “Daisy Chained Audio Speaker System” for completion.
4. A Daisy Chained Audio Speaker System according to claim 1 wherein a select numerical count of Audio Speakers (identical or non-identical) become electrically wire harnessed and forming what is now a utilitarian Audio article of Jewelry (of a chain) to be worn expressly around the Neck.

2:
1. The “Daisy Chained Audio Speaker System has no on-board power supply.
2. A Daisy Chained Audio Speaker System according to claim 2 wherein the Speaker System is solely empowered by the externally attached (by 3.5 mm Stereo or Mono Jack) Audio Input Source signal.
3. A Daisy Chained Audio Speaker System according to claim 2 wherein there are (no batteries) required for this utility to function.
4. A Daisy Chained Audio Speaker System according to claim 2 wherein the Powering Electrical Supply Source of the Daisy Chained Audio Speaker System is solely the Electrical Current of the Actual Audio Input Source as and when being supplied to the Daisy Chained Audio Speaker System when physically connected to the end-user selected Audio Input Source advent to function.
5. A Daisy Chained Audio Speaker System according to claim 2 wherein the Daisy Chained Audio Speaker System functions solely from the electrical Audio input Source electrical signal current as selected and this audio input signal current source becomes connected to by the end-user.
6. A Daisy Chained Audio Speaker System according to claim 2 wherein If?, the “Daisy Chained Audio System” is connected by the end-user to the accessory of a Bluetooth Receiver of Transmitter?, then the “Daisy Chained Audio Speaker System” is become made “Wireless”, and the Bluetooth Receiver or Transmitter is then the sole provider of the Audio Electrical Empowering Input Source Signal.
7. A Daisy Chained Audio Speaker System according to claim 2 wherein The Daisy Chained Audio Speaker System is “Plug” to an Audio Electrical Signal source, and “Play” thus at all times, “plug- and-play”.
8. The Daisy Chained Audio Speaker System may have a microphone (an optional branch) if such configured for performance.

3:
1. In the present invention application no single Audio speaker is dependent upon the next in sequence Audio speaker for the transfer of the Audio signal input electrical empowering voltage when in the (as shown) herein “parallel” electrical circuit configuration.
2. A Daisy Chained Audio Speaker System according to claim 3 wherein electrical component parts as joined in a Series or a Parallel with an (optional) Branch electrical wiring configuration forms an electrical wiring harness.
3. A Daisy Chained Audio Speaker System according to claim 3 wherein the Daisy Chained Audio Speaker System has by (2Pin Connector herein shown) detachable component parts as a means that ANY mechanical faults if ever discovered can be easily isolated and replaced or repaired (although the 2Pin Connectors are herein selected, the component parts herein could be soldered for forming the electrical circuit connectivity, “wire harness”).

4. A Daisy Chained Audio Speaker System according to claim 3 wherein the Daisy Chained Audio Speaker System has intended usage as a means to receive and transmit and provide Audio Sound as abounding around the Neck of the Human Body.

5. A Daisy Chained Audio Speaker System according to claim 3 wherein the Daisy Chained Audio Speaker System is incomplete absent the required host of an article of jewelry of a Chain (ornamental or genuine)-(simulated diamonds shown) for mounting and support.

6. A Daisy Chained Audio Speaker System according to claim 3 wherein the Daisy Chained Audio Speaker System is not bodily intrusive.

7. A Daisy Chained Audio Speaker System according to claim 3 wherein the Daisy Chained Audio Speaker System may function “Table-Top”, IF? an end user rests this utility herein upon a table top.
